(19) United States
(12) Patent Application Publication
(10) Pub. No.: US 2020/0107221 A1
(43) Pub. Date: Apr. 2, 2020

(54) ETHERNET HEADER REMOVAL FOR ETHERNET FRAME DELIVERY OVER NEW RADIO

(71) Applicant: QUALCOMM Incorporated, San Diego, CA (US)

(72) Inventors: Rajat PRAKASH, San Diego, CA (US); Peerapol TINNAKORNSRISUPHAP, San Diego, CA (US); Karl Georg HAMPEL, Hoboken, NJ (US)

(21) Appl. No.: 16/584,287

(22) Filed: Sep. 26, 2019

Related U.S. Application Data
(60) Provisional application No. 62/737,591, filed on Sep. 27, 2018.

(51) Int. Cl. H04W 28/06; H04W 28/02

(52) U.S. Cl. CPC H04W 28/06; H04W 28/0263

(57) ABSTRACT

Various aspects of the present disclosure generally relate to communication. In some aspects, a transmitter may determine that an Ethernet header is fully specified by a traffic flow template that maps traffic to a flow; determine, based at least in part on a configuration, that the Ethernet header is to be removed from traffic that maps to the flow; remove the Ethernet header from one or more packets that map to the flow based at least in part on the configuration and the determination that the Ethernet header is fully specified by the traffic flow template; and transmit the one or more packets via the flow. Numerous other aspects are provided, including a receiver and a network device.

### CROSS-REFERENCE TO RELATED APPLICATION

This application claims priority to U.S. Provisional Patent Application No. 62/737,591, filed on Sep. 27, 2018, entitled “ETHERNET HEADER REMOVAL FOR ETHERNET FRAME DELIVERY OVER NEW RADIO,” which is hereby expressly incorporated by reference herein.

### FIELD OF THE DISCLOSURE

Aspects of the present disclosure generally relate to wireless communication and to techniques and apparatuses for Ethernet header removal for Ethernet frame delivery over New Radio.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of communication, performed by a transmitter, may include determining that an Ethernet header is fully specified by a traffic flow template that maps traffic to a flow; determining, based at least in part on a configuration, that the Ethernet header is to be removed from traffic that maps to the flow; removing the Ethernet header from one or more packets that map to the flow based at least in part on the configuration and the determination that the Ethernet header is fully specified by the traffic flow template; and transmitting the one or more packets, without the Ethernet header, via the flow.

In some aspects, a transmitter for communication may include memory and one or more processors coupled to the memory. The memory and the one or more processors may be configured to determine that an Ethernet header is fully specified by a traffic flow template that maps traffic to a flow; determine, based at least in part on a configuration, that the Ethernet header is to be removed from traffic that maps to the flow; remove the Ethernet header from one or more packets that map to the flow based at least in part on the configuration and the determination that the Ethernet header is fully specified by the traffic flow template; and transmit the one or more packets, without the Ethernet header, via the flow.

In some aspects, a non-transitory computer-readable medium may store one or more instructions for communication. The one or more instructions, when executed by one or more processors of a transmitter, may cause the one or more processors to determine that an Ethernet header is fully specified by a traffic flow template that maps traffic to a flow; determine, based at least in part on a configuration, that the Ethernet header is to be removed from traffic that maps to the flow; remove the Ethernet header from one or more packets that map to the flow based at least in part on the configuration and the determination that the Ethernet header is fully specified by the traffic flow template; and transmit the one or more packets, without the Ethernet header, via the flow.

In some aspects, an apparatus for communication may include means for determining that an Ethernet header is fully specified by a traffic flow template that maps traffic to a flow; means for determining, based at least in part on a configuration, that the Ethernet header is to be removed from traffic that maps to the flow; means for removing the Ethernet header from one or more packets that map to the flow based at least in part on the configuration and the determination that the Ethernet header is fully specified by the traffic flow template; and means for transmitting the one or more packets, without the Ethernet header, via the flow.

In some aspects, a method of communication, performed by a receiver, may include identifying a flow associated with a received packet; determining that the flow is associated with a configuration indicating that an Ethernet header is to be removed from traffic associated with the flow; determining values for fields of the Ethernet header based at least in part on the configuration; and reconstructing the Ethernet header for the received packet using the determined values for the fields based at least in part on the determination that the flow is associated with the configuration indicating that the Ethernet header is to be removed.

In some aspects, a receiver for communication may include memory and one or more processors coupled to the memory. The memory and the one or more processors may be configured to identify a flow associated with a received packet; determine that the flow is associated with a configuration indicating that an Ethernet header is to be removed from traffic associated with the flow; determine values for fields of the Ethernet header based at least in part on the configuration; and reconstruct the Ethernet header for the received packet using the determined values for the fields based at least in part on the determination that the flow is associated with the configuration indicating that the Ethernet header is to be removed.

In some aspects, a non-transitory computer-readable medium may store one or more instructions for communication. The one or more instructions, when executed by one or more processors of a receiver, may cause the one or more processors to identify a flow associated with a received packet; determine that the flow is associated with a configuration indicating that an Ethernet header is to be removed from traffic associated with the flow; determine values for fields of the Ethernet header based at least in part on the configuration; and reconstruct the Ethernet header for the received packet using the determined values for the fields based at least in part on the determination that the flow is associated with the configuration indicating that the Ethernet header is to be removed.

In some aspects, an apparatus for communication may include means for identifying a flow associated with a received packet; means for determining that the flow is associated with a configuration indicating that an Ethernet header is to be removed from traffic associated with the flow; means for determining values for fields of the Ethernet header based at least in part on the configuration; and means for reconstructing the Ethernet header for the received packet using the determined values for the fields based at least in part on the determination that the flow is associated with the configuration indicating that the Ethernet header is to be removed.

In some aspects, a method of communication, performed by a network device, may include determining that an Ethernet header is fully specified by a traffic flow template that maps traffic to a flow; determining that the Ethernet header is to be removed from traffic that maps to the flow based at least in part on determining that the Ethernet header is fully specified by the traffic flow template; and transmitting a configuration that indicates that the Ethernet header is to be removed from traffic that maps to the flow.

In some aspects, a network device for communication may include memory and one or more processors coupled to the memory. The memory and the one or more processors may be configured to determine that an Ethernet header is fully specified by a traffic flow template that maps traffic to a flow; determine that the Ethernet header is to be removed from traffic that maps to the flow based at least in part on determining that the Ethernet header is fully specified by the traffic flow template; and transmit a configuration that indicates that the Ethernet header is to be removed from traffic that maps to the flow.

In some aspects, a non-transitory computer-readable medium may store one or more instructions for communication. The one or more instructions, when executed by one or more processors of a network device, may cause the one or more processors to determine that an Ethernet header is fully specified by a traffic flow template that maps traffic to a flow; determine that the Ethernet header is to be removed from traffic that maps to the flow based at least in part on determining that the Ethernet header is fully specified by the traffic flow template; and transmit a configuration that indicates that the Ethernet header is to be removed from traffic that maps to the flow.

In some aspects, an apparatus for communication may include means for determining that an Ethernet header is fully specified by a traffic flow template that maps traffic to a flow; means for determining that the Ethernet header is to be removed from traffic that maps to the flow based at least in part on determining that the Ethernet header is fully specified by the traffic flow template; and means for transmitting a configuration that indicates that the Ethernet header is to be removed from traffic that maps to the flow.

Aspects generally include a method, apparatus, system, computer program product, non-transitory computer-readable medium, user equipment, base station, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3 is a diagram illustrating example Ethernet headers, in accordance with various aspects of the present disclosure.

FIGS. 4-7 are diagrams illustrating examples of Ethernet header removal for Ethernet frame delivery over New Radio, in accordance with various aspects of the present disclosure.

FIGS. 8A and 8B are diagrams illustrating examples of fully specified and non-fully specified Ethernet headers, in accordance with various aspects of the present disclosure.

FIGS. 9-11 are diagrams illustrating example processes relating to Ethernet header removal for Ethernet frame delivery over New Radio, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It is noted that while aspects may be described herein using terminology commonly associated with 3G and/or 4G wireless technologies, aspects of the present disclosure can be applied in other generation-based communication systems, such as 5G and later, including NR technologies.

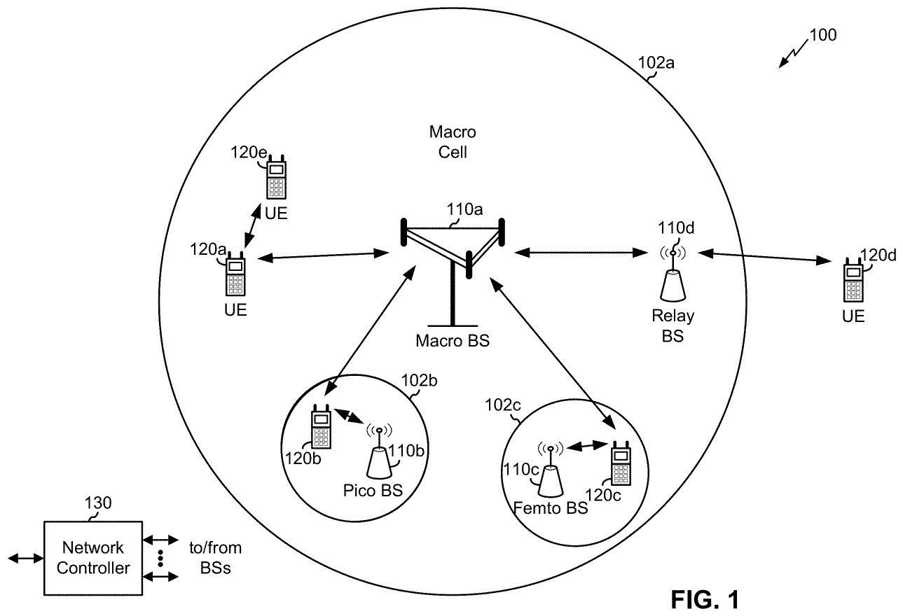

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul. The network controller 130 may include, for example, a device that provides a user plane function (UPF), a device that provides an access management function (AMF), a device that provides a session management function (SMF) device, a mobility management entity (MME), a serving gateway (SGW), a packet data network (PDN) gateway (PGW), a device that provides an application function, and/or the like.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, such as sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

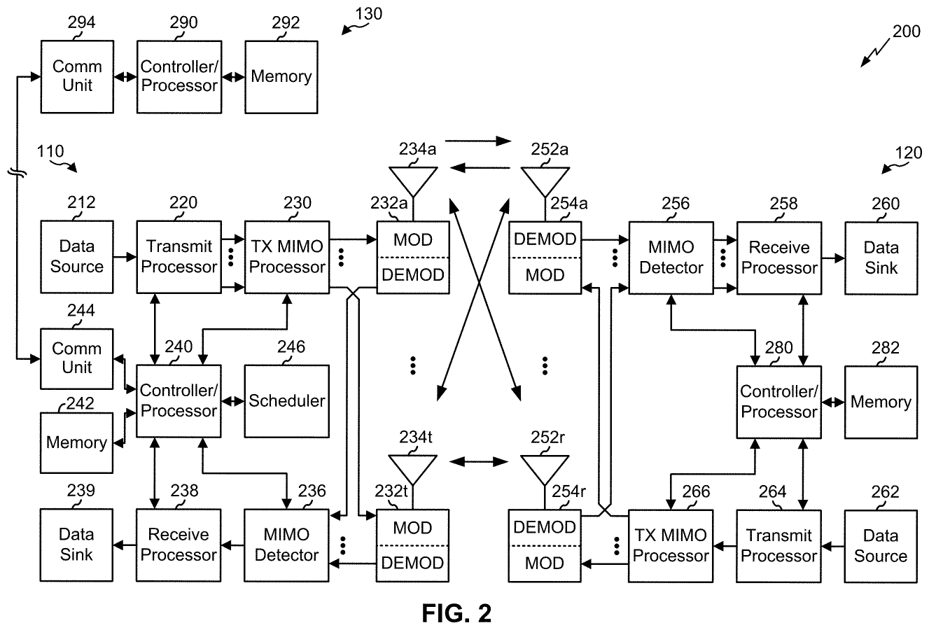

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

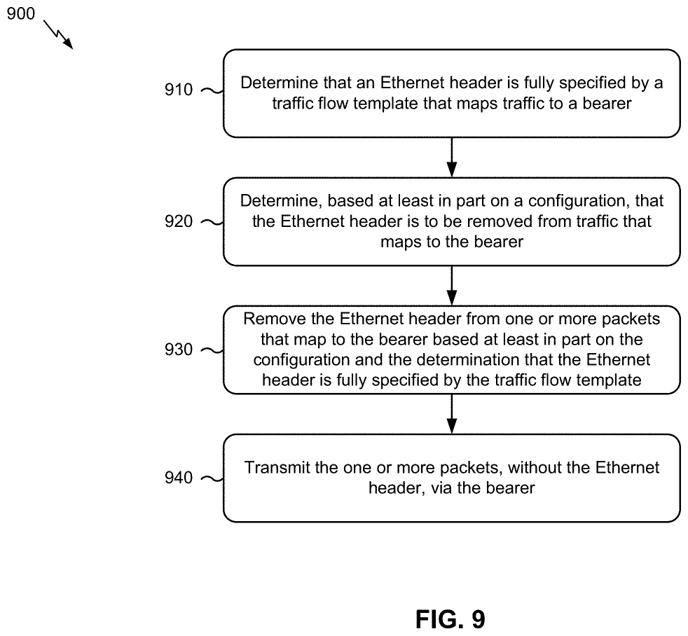

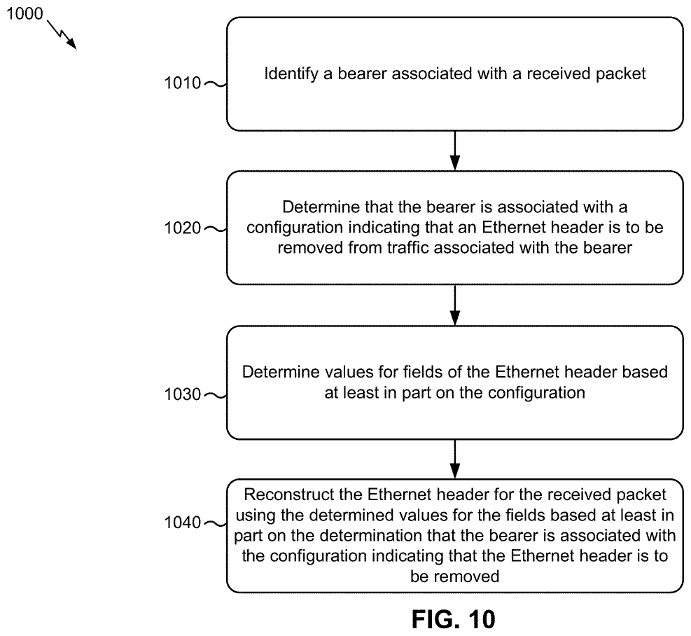

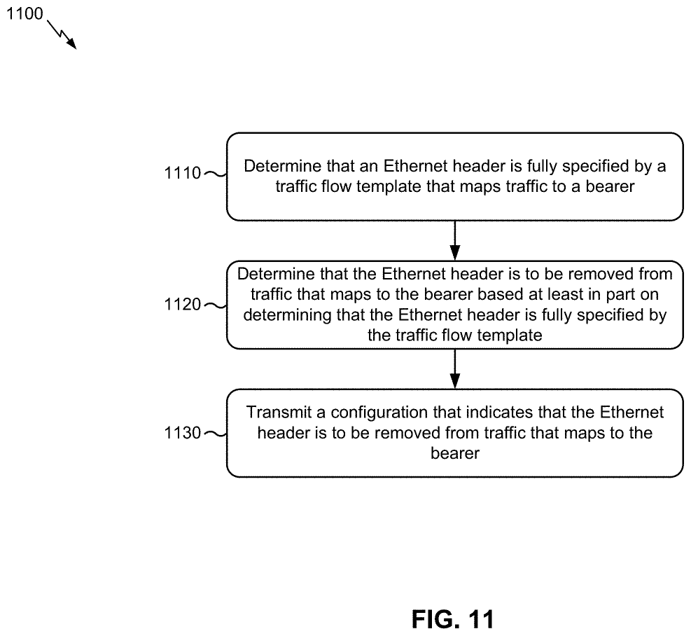

Controller/processor 240 of base station 110, controller/processor 280 of UE 120, controller/processor 290 of network controller 130, and/or any other component(s) of FIG. 2 may perform one or more techniques associated with Ethernet header removal for Ethernet frame delivery over New Radio, as described in more detail elsewhere herein. For example, controller/processor 240 of base station 110, controller/processor 280 of UE 120, controller/processor 290 of network controller 130, and/or any other component(s) of FIG. 2 may perform or direct operations of, for example, process 900 of FIG. 9, process 1000 of FIG. 10, process 1100 of FIG. 11, and/or other processes as described herein. Memories 242, 282, and 292 may store data and program codes for base station 110, UE 120, and network controller 130, respectively. A scheduler 246 may schedule UEs for data transmission on the downlink and/or uplink.

In some aspects, a transmitter (e.g., a base station 110, a UE 120, a network controller 130, and/or the like) may include means for determining that an Ethernet header is fully specified by a traffic flow template that maps traffic to a flow; means for determining, based at least in part on a configuration, that the Ethernet header is to be removed from traffic that maps to the flow; means for removing the Ethernet header from one or more packets that map to the flow based at least in part on the configuration and the determination that the Ethernet header is fully specified by the traffic flow template; means for transmitting the one or more packets, without the Ethernet header, via the flow; and/or the like. Additionally, or alternatively, a receiver (e.g., a base station 110, a UE 120, a network controller 130, and/or the like) may include means for identifying a flow associated with a received packet; means for determining that the flow is associated with a configuration indicating that an Ethernet header is to be removed from traffic associated with the flow; means for determining values for fields of the Ethernet header based at least in part on the configuration; means for reconstructing the Ethernet header for the received packet using the determined values for the fields based at least in part on the determination that the flow is associated with the configuration indicating that the Ethernet header is to be removed; and/or the like. Additionally, or alternatively, a network device (e.g., a base station 110, a network controller 130, and/or the like) may include means for determining that an Ethernet header is fully specified by a traffic flow template that maps traffic to a flow; means for determining that the Ethernet header is to be removed from traffic that maps to the flow based at least in part on determining that the Ethernet header is fully specified by the traffic flow template; means for transmitting a configuration that indicates that the Ethernet header is to be removed from traffic that maps to the flow; and/or the like. In some aspects, such means may include one or more components of base station 110, UE 120, and/or network controller 130 described in connection with FIG. 2.

As indicated above, FIG. 2 is provided as an example. Other examples may differ from what is described with regard to FIG. 2.

In New Radio and other types of radio access technologies, Ethernet frames may be transported over a wireless wide area network (WWAN), such as a cellular network, a 5G network, and/or the like. For example, a packet data network (PDN) and corresponding protocols have been defined for transporting Ethernet traffic over 5G, sometimes referred to as Ethernet over packet data convergence protocol (PDCP). In some cases, a header for an Ethernet frame (e.g., an Ethernet header) may contribute significant overhead to the overall size of a packet that includes the Ethernet frame. For example, an Ethernet header may be 14 bytes, 18 bytes, 22 bytes, or more. In some scenarios, such as factory automation, the overall size of transported packets may be small, such as between 20 bytes and 50 bytes. In these cases, when an Ethernet header is included in each packet, the Ethernet header may significantly increase the size of the packet (e.g., a 28% increase or more, including up to a 110% increase or more). Some techniques and apparatuses described herein significantly reduce the amount of overhead created by Ethernet headers transported over a 5G network or a similar type of network, such as by removing the Ethernet headers when certain conditions are satisfied.

Furthermore, overhead caused by transporting Ethernet headers requires network resources (e.g., time resources, frequency resources, spatial resources, resource elements, and/or the like) that could otherwise be used to transport other network traffic. In scenarios with a low latency requirement and/or a high reliability requirement (e.g., factory automation, ultra reliable low latency communications (URLLC), and/or the like), transporting Ethernet headers over a 5G network or a similar type of network may reduce the likelihood that network traffic delivery satisfies such requirements. Accordingly, some techniques and apparatuses described herein conserve network resources and assist with satisfying latency requirements, reliability requirements, and/or the like by reducing Ethernet header overhead.

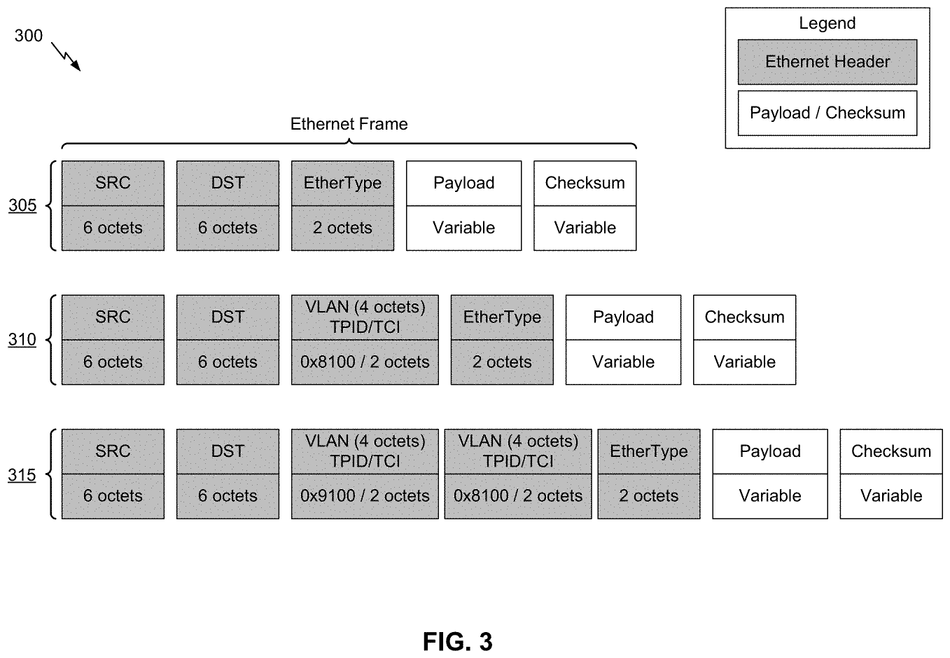

FIG. 3 is a diagram illustrating example Ethernet headers, in accordance with various aspects of the present disclosure.

FIG. 3 shows three different types of Ethernet headers of an Ethernet frame. As shown, different fields may be included in the Ethernet header depending on a specific Ethernet protocol being used to communicate. For example, a different number of fields may be included in the Ethernet header depending on whether virtual local area network (VLAN) information is carried in the Ethernet header and a number of VLANs for which VLAN information is carried in the Ethernet header. As a result, the size of the Ethernet header may vary depending on such factors.

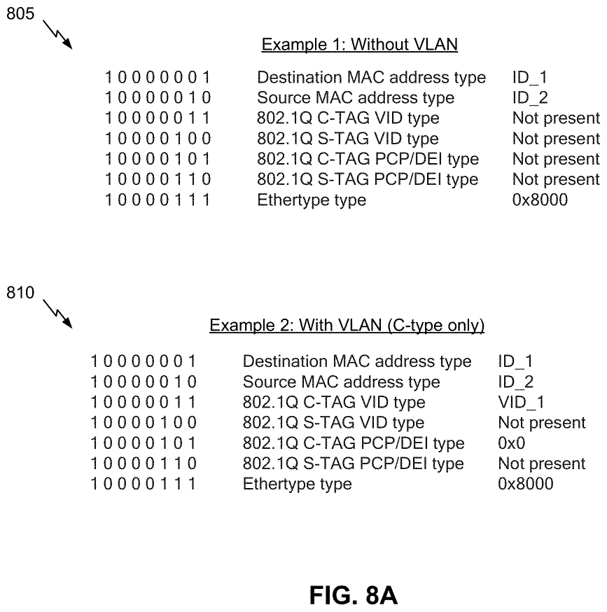

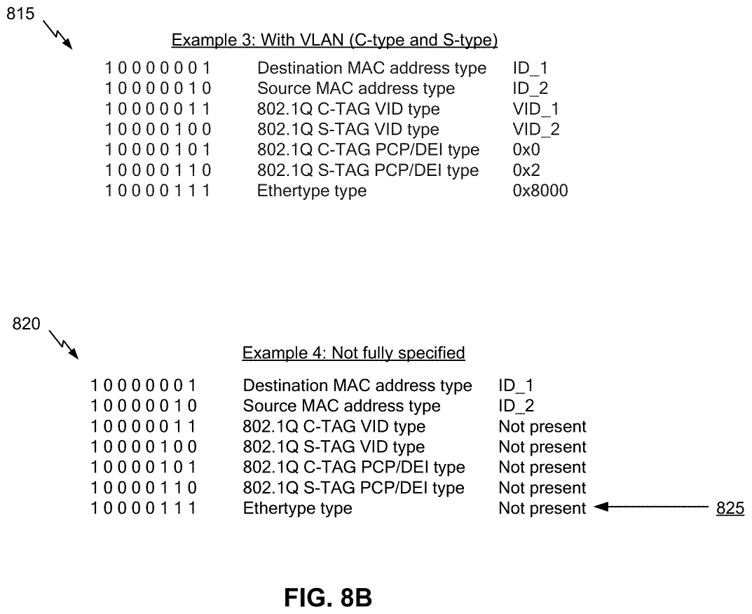

As shown by reference number 305, a first type of Ethernet header may be used when VLAN tagging is not used. In this case, the Ethernet header may include a source address identifier (e.g., a source media access control (MAC) address and/or the like, shown as SRC), a destination address identifier (e.g., a destination MAC address and/or the like, shown as DST), and an EtherType identifier used to indicate the type of protocol encapsulated in the payload of the Ethernet frame and/or the size of the Ethernet frame. In the first type of Ethernet header, the source address identifier may be 6 bytes, the destination address identifier may be 6 bytes, and the EtherType identifier may be 2 bytes, for a total of 14 bytes for the Ethernet header. This first type of Ethernet header is also shown by reference number 805 of FIG. 8A.

As shown by reference number 310, a second type of Ethernet header may be used when VLAN tagging is used, and when a single VLAN tag is used (e.g., sometimes referred to as single tagging). In this case, the Ethernet header may include the source address identifier, the destination address identifier, the EtherType identifier, and a single VLAN tag field. A VLAN tag field may sometimes be referred to as an 802.1Q tag, and may include a tag protocol identifier (TPID) field (e.g., 2 bytes) and a tag control information (TCI) field (e.g., 2 bytes). The TCI field may include a priority code point (PCP) field (e.g., 3 bits), a drop eligible indicator (DEI) field (e.g., 1 bit), and a VLAN identifier (VID) field (e.g., 12 bits). In some aspects, if the Ethernet header includes a single VLAN tag field, that VLAN tag field may be referred to as a customer tag (C-TAG) field. In the second type of Ethernet header, the source address identifier may be 6 bytes, the destination address identifier may be 6 bytes, the EtherType identifier may be 2 bytes, and the VLAN tag field may be 4 bytes, for a total of 18 bytes for the Ethernet header. This second type of Ethernet header is also shown by reference number 810 of FIG. 8A.

As shown by reference number 315, a third type of Ethernet header may be used when VLAN tagging is used, and when two VLAN tags are used (e.g., sometimes referred to as double tagging). In this case, the Ethernet header may include the source address identifier, the destination address identifier, the EtherType identifier, a first VLAN tag field, and a second VLAN tag field. In some aspects, if the Ethernet header includes two VLAN tag fields, one of the VLAN tag fields may be referred to as a customer tag (C-TAG) field, and the other VLAN tag field may be referred to as a service tag (S-TAG) field. In the third type of Ethernet header, the source address identifier may be 6 bytes, the destination address identifier may be 6 bytes, the EtherType identifier may be 2 bytes, the first VLAN tag field may be 4 bytes, and the second VLAN tag field may be 4 bytes, for a total of 22 bytes for the Ethernet header. This third type of Ethernet header is also shown by reference number 815 of FIG. 8B.

Thus, as indicated above, the Ethernet header may contribute between 14 bytes and 22 bytes of overhead to a packet that carries Ethernet frames over PDCP, 5G, and/or the like. The types of Ethernet headers described above and shown in FIG. 3 are provided as examples, and other types of Ethernet headers (e.g., of different size) may be used in some cases. As will be described in more detail below, some techniques and apparatuses described herein reduce packet overhead by removing Ethernet headers when certain conditions are satisfied. Some of these techniques may be performed in association with packet filtering, thereby improving efficiencies in Ethernet header removal.

As indicated above, FIG. 3 is provided as an example. Other examples may differ from what is described with regard to FIG. 3.

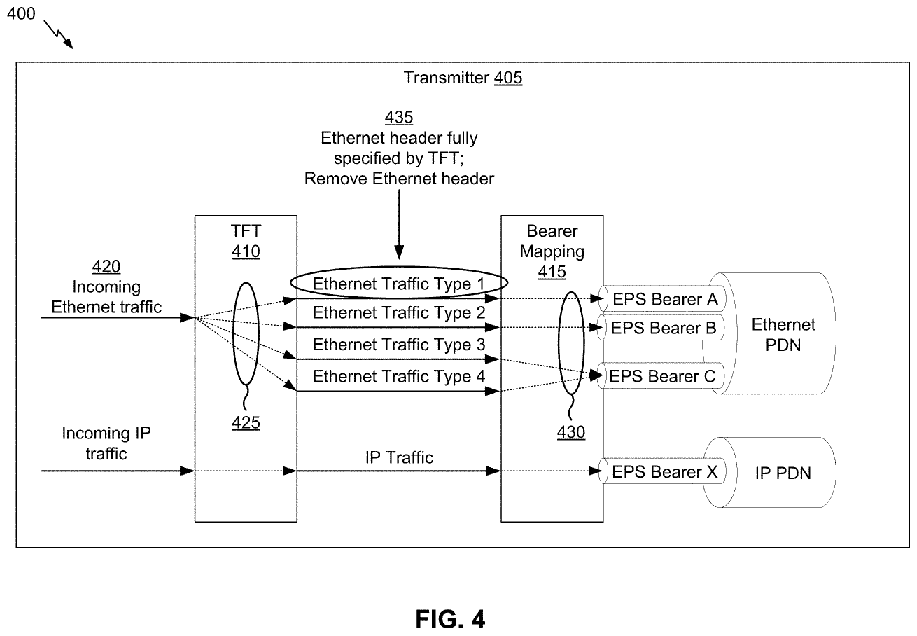

FIG. 4 is a diagram illustrating an example 400 of Ethernet header removal for Ethernet frame delivery over New Radio, in accordance with various aspects of the present disclosure.

As shown in FIG. 4, a transmitter 405 (e.g., a base station 110, a UE 120, a network controller 130, such as a UPF device, an application function device, and/or the like) may include a traffic flow template (TFT) component 410 and a bearer mapping component 415. The TFT component 410 may store one or more traffic flow templates, and may use the traffic flow templates to map incoming traffic (e.g., traffic input in to the TFT component 410) to a specific traffic flow. A traffic flow may refer to a set of related packets, such as packets having one or more field values that match a specific value or a set of values.

For example, as shown by reference number 420, the TFT component 410 may receive Ethernet traffic (e.g., Ethernet frames), and may map the Ethernet traffic to a traffic flow based on a type of the Ethernet traffic. The type may be determined based at least in part on a set of values in a corresponding set of fields of the Ethernet traffic, such as fields of an Ethernet header, as described above in connection with FIG. 3. The TFT component 410 may read the Ethernet header of an incoming Ethernet frame, determine whether one or more field values of the Ethernet header satisfy a set of conditions (e.g., match one or more values of a set of stored values), and may map the Ethernet frame to a specific traffic flow (e.g., shown as Ethernet Traffic Types 1 through 4), as shown by reference number 425. The TFT component 410 may map the Ethernet frame to a traffic flow based at least in part on which conditions are satisfied (e.g., using sequential filters) and/or whether any conditions are satisfied. In some aspects, if the Ethernet frame does not match any of the stored traffic flow templates, then the TFT component 410 may map the Ethernet frame to a default flow. As shown, the TFT component 410 may perform similar operations for other types of network traffic, such as internet protocol (IP) traffic (e.g., by reading an IP header).

As shown by reference number 430, the bearer mapping component 415 may map network traffic (e.g., Ethernet traffic, IP traffic, and/or the like) to a bearer (e.g., a radio bearer, and evolved packet system (EPS) bearer, and/or the like) based at least in part on the type of the network traffic. A bearer may carry one or more classes of network traffic, and may be assigned a quality of service class indicator (QCI) value for traffic prioritization. In some cases, there may be a one-to-one mapping of traffic type to bearer, as shown by Ethernet Traffic Type 1 being mapped to EPS Bearer A and Ethernet Traffic Type 2 being mapped to EPS Bearer B. In some cases, there may be a many-to-one mapping of traffic type to bearer, as shown by Ethernet Traffic Types 3 and 4 being mapped to EPS Bearer C. As shown, the transmitter 405 may transmit Ethernet traffic on bearers associated with an Ethernet PDN. As shown, the bearer mapping component 415 may perform similar operations for other types of network traffic, such as IP traffic. Although some techniques are described herein in connection with a bearer (e.g., mapping network traffic to a bearer), these techniques may also apply to another type of flow (e.g., a traffic flow, a bearer, a group of related packets, and/or the like). Thus, the term “flow” may be substituted for the term “bearer” herein, and vice versa.

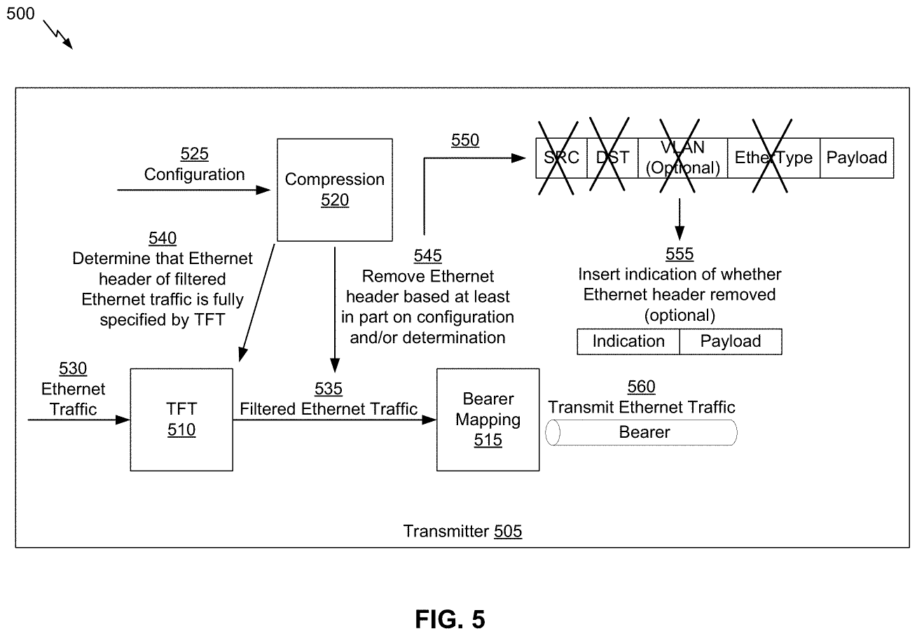

As shown by reference number 435, in some aspects, an Ethernet header may be fully specified by a traffic flow template stored by the TFT component 410. For example, the traffic flow template may include a specific value for all required fields of the Ethernet header (e.g., depending on a type of Ethernet header), and the values of those required fields in the Ethernet header may match the values included in the traffic flow template for each of those required fields. Additional details explaining fully specified Ethernet headers are described below in connection with FIG. 5. In this case, only a single type of Ethernet traffic is transmitted on a specific bearer. As will be described in more detail below in connection with FIG. 5, the transmitter 405 may remove the Ethernet header from a packet when the Ethernet header is fully specified by a traffic flow template, thereby conserving network resources, reducing overhead, and/or the like. In the case where multiple types of Ethernet traffic (e.g., having different values in respective Ethernet headers) map to a single bearer (e.g., shown as Ethernet Traffic Types 3 and 4 mapping to EPS Bearer C), the transmitter 405 may not remove the Ethernet header because the Ethernet header is not fully specified by the traffic flow template in this case. Additional details of operations performed by the transmitter 405 are provided below in connection with FIG. 5.

In some aspects, the removal of the Ethernet header may be performed by the TFT component 410, the bearer mapping component 415, and/or another component of the transmitter 405. In some aspects, the Ethernet header may be removed after and/or in connection with filtering traffic using traffic flow templates. Additionally, or alternatively, the Ethernet header may be removed after and/or in connection with mapping traffic to a bearer.

As indicated above, FIG. 4 is provided as an example. Other examples may differ from what is described with regard to FIG. 4.

FIG. 5 is a diagram illustrating another example 500 of Ethernet header removal for Ethernet frame delivery over New Radio, in accordance with various aspects of the present disclosure.

FIG. 5 shows example operations performed by a transmitter 505 in connection with Ethernet header removal for Ethernet frame delivery over New Radio (e.g., over PDCP). In some aspects, the transmitter 505 may correspond to the transmitter 405 described above in connection with FIG. 4. Additionally, or alternatively, the transmitter 505 may be a base station 110, a UE 120, a network controller 130 (e.g., a UPF device and/or the like), and/or the like. As shown, the transmitter 505 may include a TFT component 510 (e.g., which may correspond to the TFT component 410 of FIG. 4), a bearer mapping component 515 (e.g., which may correspond to the bearer mapping component 415 of FIG. 4), and/or a compression component 520. These components may include hardware, firmware, or a combination of hardware and software. For example, these components may include one or more components described above in connection with FIG. 2. In some aspects, the compression component 520 may be integrated into the TFT component 510 and/or the bearer mapping component 515. Alternatively, the compression component 520 may be a separate component.

As shown by reference number 525, the transmitter 505 (e.g., the compression component 520) may determine a configuration relating to Ethernet header compression for Ethernet frames to be transported over PDCP, 5G, and/or the like. In some aspects, the transmitter 505 may receive the configuration from another device. For example, a UE 120 may receive the configuration from a base station 110 (e.g., when may generate the configuration and/or receive the configuration from a network controller 130). Additionally, or alternatively, a base station 110 may receive the configuration from a network controller 130 (e.g., a UPF device). In some aspects, the transmitter 505 may generate the configuration. For example, a base station 110 and/or a network controller 130 may generate the configuration.

The configuration may indicate whether an Ethernet header is to be removed from traffic (e.g., network traffic, one or more packets, and/or the like) that maps to a specific bearer. Additionally, or alternatively, the configuration may indicate whether an Ethernet header is to be removed from traffic when the Ethernet header is fully specified by a traffic flow template (e.g., that maps the traffic to a specific bearer). In some aspects, the configuration may be generated and/or indicated in association with establishing the specific bearer. Additionally, or alternatively, the configuration may be indicated in a radio resource control (RRC) message (e.g., an RRC configuration message, an RRC reconfiguration message, and/or the like), a non-access stratum (NAS) message, and/or the like. Additionally, or alternatively, the configuration may be signaled using a traffic flow template format, thereby increasing efficiency when header removal is applied in combination with traffic flow template filtering.

In some aspects, the configuration may indicate whether the transmitter 505 is to transmit packets, that include Ethernet frames, with or without an indication of whether the Ethernet header has been removed from the packets. This indication may be used by a receiver of the packets to determine whether the packets include Ethernet headers, to determine whether the receiver is to reconstruct the Ethernet headers for the packets, and/or the like.

As shown by reference number 530, the TFT component 510 may receive Ethernet traffic to be transmitted on a bearer (e.g., via 5G, PDCP, and/or the like), as described above in connection with FIG. 4. The TFT component 510 may apply one or more filters to the incoming Ethernet traffic to generate filtered Ethernet traffic that maps to a traffic flow, as shown by reference number 535 and as described above in connection with FIG. 4.

As shown by reference number 540, the compression component 520 may determine that an Ethernet header of the filtered Ethernet traffic is fully specified by a traffic flow template stored by the TFT component 510. The Ethernet header may be fully specified by a traffic flow template when the traffic flow template includes a specific value (e.g., and not a range of values) for all required fields of the Ethernet header, and each of those specific values match a corresponding value for a corresponding field included in the Ethernet header (e.g., of incoming Ethernet traffic).

For a first type of Ethernet traffic, the required fields may be the source address field, the destination address field, and the EtherType field (e.g., as shown by reference number 805 of FIG. 8A). For other types of Ethernet headers, the required fields may be the source address field, the destination address field, the EtherType field, and all VLAN tag fields, which may include a single VLAN tag field in the case of single tagging (e.g., as shown by reference number 810 of FIG. 8A) or two VLAN tag fields in the case of double tagging (e.g., as shown by reference number 815 of FIG. 8B). For example, for a second type of Ethernet header, the required fields may be the source address field, the destination address field, the EtherType field, and a single VLAN tag field (e.g., as shown by reference number 810 of FIG. 8A). For a third type of Ethernet header, the required fields may be the source address field, the destination address field, the EtherType field, a first VLAN tag field (e.g., a C-TAG field), and a second VLAN tag field (e.g., an S-TAG field) (e.g., as shown by reference number 815 of FIG. 8B). Additionally, or alternatively, the Ethernet header may be fully specified by a traffic flow template when only packets with the same Ethernet header (e.g., the same values for Ethernet header fields) map to a flow and/or bearer indicated by the traffic flow template.

If the traffic flow template does not store a specific value for one or more required fields of the Ethernet header, then the traffic flow template cannot fully specify any Ethernet header (e.g., as shown by reference number 820 of FIG. 8B, where the traffic flow template does not store a specific value for the EtherType field, as shown by reference number 825 of FIG. 8B). For a specific Ethernet header, if a value of any required field of that specific Ethernet header does not match a corresponding value stored by the traffic flow template (e.g., for the same field), then that specific Ethernet header is not fully specified by the traffic flow template.

As shown by reference number 545, the compression component 520 may remove the Ethernet header from the filtered Ethernet traffic (e.g., one or more packets) based at least in part on the configuration and/or the determination that the Ethernet header of the filtered Ethernet traffic is fully specified by a traffic flow template. In some aspects, the configuration may indicate that an Ethernet header is to be removed from Ethernet traffic that maps to a specific bearer, and the compression component 520 may remove the Ethernet header from the Ethernet traffic based at least in part on determining that the Ethernet traffic maps to the specific bearer. In some cases, the compression component 520 need not determine whether the Ethernet header is fully specified by a traffic flow template because the configuration may ensure that only fully specified Ethernet headers are configured for Ethernet header removal.

In some aspects (e.g., if the configuration does not ensure that only fully specified Ethernet headers are configured for Ethernet header removal), then the compression component 520 may determine whether the Ethernet header is fully specified, and may remove the Ethernet header if the Ethernet header is fully specified. In some aspects, the Ethernet header may be removed by default if the Ethernet header is fully specified. Additionally, or alternatively, the compression component 520 may determine whether a configuration for the bearer indicates that the Ethernet header is to be removed from Ethernet traffic that maps to the bearer. In this case, if the configuration indicates that the Ethernet header is to be removed and if the Ethernet header is fully specified, then the compression component 520 may remove the Ethernet header. However, if the configuration indicates that the Ethernet header is not to be removed, then the compression component 520 may refrain from removing the Ethernet header regardless of whether the Ethernet header is fully specified by a traffic flow template.

As shown by reference number 550, removing the Ethernet header may include removing all fields of the Ethernet header from the packet(s) to be transmitted (but leaving the Ethernet payload). For example, for a first type of Ethernet header, the compression component 520 may remove all values of the source address field, the destination address field, and the EtherType field. For other types of Ethernet headers, the compression component 520 may remove all values of the source address field, the destination address field, the EtherType field, and all VLAN tag fields. For example, for a second type of Ethernet header, the compression component 520 may remove all values of the source address field, the destination address field, the EtherType field, and a single VLAN tag field. Similarly, for a third type of Ethernet header, the compression component 520 may remove all values of the source address field, the destination address field, the EtherType field, a first VLAN tag field (e.g., a C-TAG field), and a second VLAN tag field (e.g., an S-TAG field).

As shown by reference number 555, in some aspects, the transmitter 505 may insert, in a packet that includes an Ethernet payload, an indication of whether an Ethernet header was removed from the packet. As described above, in some aspects, the configuration may indicate whether to insert this indication, and the transmitter 505 may determine whether to insert this indication based at least in part on the configuration. In some aspects, Ethernet headers may be removed from all packets transmitted via a specific bearer, and a receiver may be notified as such. In this case, the receiver does not need an indication of whether the Ethernet header has been removed from a packet transmitted via the specific bearer. Thus, the indication need not be transmitted, thereby conserving processing power, network resources, and/or the like. However, in some cases, Ethernet headers may not be removed from all packets transmitted via a specific bearer. In this case, the receiver may need an indication of whether the Ethernet header has been removed from a packet in order to properly process the packet.

In some aspects, if the indication of whether the Ethernet header has been removed is included in the packet, the indication may be included in a field of a service data adaptation protocol (SDAP) header and/or a field of a PDCP header. In some aspects, the indication may be a single bit, which may be set to a first value (e.g., 1) when the Ethernet header has been removed, or may be set to a second value (e.g., 0) when the Ethernet header has not been removed.

As shown by reference number 560, the transmitter 505 may transmit the Ethernet traffic (e.g., one or more packets that include the Ethernet payload) via a bearer to which the Ethernet traffic is mapped (e.g., by the bearer mapping component 515). If the Ethernet header is removed from a packet, then the portion of the packet that carries the Ethernet frame may include only the Ethernet payload (e.g., and not the Ethernet header). If the Ethernet header is not removed from a packet, then the portion of the packet that carries the Ethernet frame may include the Ethernet payload and the Ethernet header. In either case, the Ethernet checksum (e.g., cyclic redundancy check (CRC)) may be removed from the packet (e.g., via a PDCP function). In some aspects, the packet may include an indication of whether the Ethernet header was removed (e.g., according to a configuration), as described above.

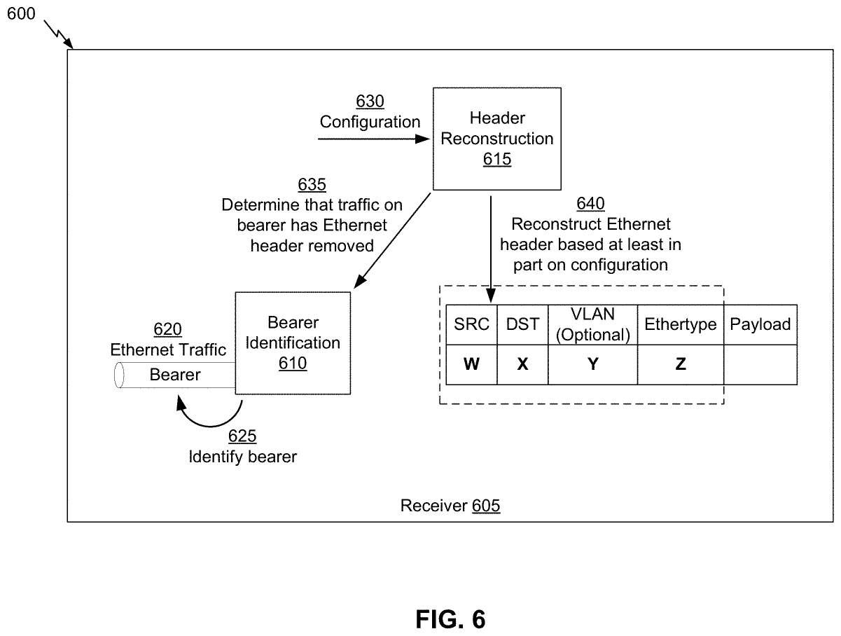

By removing the Ethernet header when the Ethernet header is fully specified by the traffic flow template, network resources may be conserved without negatively impacting reception of an Ethernet frame, since a receiver will be capable of reconstructing the Ethernet header due to the full specification of the Ethernet header by the traffic flow template, as described in more detail below in connection with FIG. 6. In this way, an amount of overhead created by Ethernet headers transported over a 5G, PDCP, and/or the like may be reduced. This may save significant overhead, particularly for small payloads and/or packet sizes.

As indicated above, FIG. 5 is provided as an example. Other examples may differ from what is described with regard to FIG. 5.

FIG. 6 is a diagram illustrating another example 600 of Ethernet header removal for Ethernet frame delivery over New Radio, in accordance with various aspects of the present disclosure.

FIG. 6 shows example operations performed by a receiver 605 in connection with Ethernet header removal for Ethernet frame delivery over New Radio (e.g., over PDCP). In some aspects, the receiver 605 may be a base station 110, a UE 120, a network controller 130 (e.g., a UPF device and/or the like), and/or the like. As shown, the receiver 605 may include a bearer identification component 610 and/or a header reconstruction component 615. These components may include hardware, firmware, or a combination of hardware and software. For example, these components may include one or more components described above in connection with FIG. 2.

As shown by reference number 620, the receiver 605 may receive a packet, which may include Ethernet traffic. For example, the packet may be a packet that includes an Ethernet payload, which may be transmitted by a transmitter 505, as described above in connection with FIG. 5.

As shown by reference number 625, the receiver 605 (e.g., the bearer identification component 610) may identify a bearer associated with the received packet. For example, the bearer may be identified based at least in part on a QCI value, a bearer identifier, and/or the like, which may be included in the packet.

As shown by reference number 630, the receiver 605 (e.g., the header reconstruction component 615) may determine a configuration relating to Ethernet header compression for Ethernet frames to be transported over PDCP, 5G, and/or the like, in a similar manner as described above in connection with FIG. 5. In some aspects, the receiver 605 may receive the configuration from another device. For example, a UE 120 may receive the configuration from a base station 110. Additionally, or alternatively, a base station 110 may receive the configuration from a network controller 130. In some aspects, the receiver 605 may generate the configuration. For example, a base station 110 and/or a network controller 130 may generate the configuration. The configuration may be associated with a bearer.

As described above in connection with FIG. 5, in some aspects, the configuration may be generated and/or indicated in association with establishing the bearer. Additionally, or alternatively, the configuration may be indicated in an RRC message, a NAS message, and/or the like. Additionally, or alternatively, the configuration may be signaled using a traffic flow template format.

As shown by reference number 635, the receiver 605 (e.g., the header reconstruction component 615) may determine that an Ethernet header has been removed from traffic on the bearer. For example, the receiver 605 may determine that the bearer is associated with a configuration indicating that an Ethernet header is to be removed from traffic associated with the bearer. In some aspects, the configuration may indicate that all packets received via a specific bearer will be received without an Ethernet header (e.g., will have the Ethernet header removed). In this case, the receiver 605 may determine that an Ethernet header has been removed from a packet when the packet is received via the specific bearer, and may reconstruct an Ethernet header for the packet, as described below. In some aspects, the configuration may indicate that a packet received via a specific bearer will include an indication of whether an Ethernet header has been removed from the packet (e.g., in an SDAP header, a PDCP header, and/or the like). In this case, the receiver 605 may read the indication from the packet to determine whether the Ethernet header has been removed from the packet. If the indication indicates that the Ethernet header has been removed from the packet, then the receiver 605 may reconstruct an Ethernet header for the packet, as described below.

As shown by reference number 640, the receiver 605 (e.g., the header reconstruction component 615) may reconstruct the Ethernet header for the Ethernet frame in the packet based at least in part on the configuration. For example, the configuration may indicate values for fields of the Ethernet header (e.g., a source address field, a destination address field, an EtherType field, and/or one or more VLAN tag fields), and the receiver 605 may read the configuration to determine specific values to be inserted in specific fields of the Ethernet header. The receiver 605 may recreate the fields and/or insert the indicated values in those fields to reconstruct the Ethernet header.

By removing an Ethernet header at a transmitter when the Ethernet header is fully specified by the traffic flow template, such that the Ethernet header can be reconstructed by a receiver 605 (e.g., due to a mapping of Ethernet header values to a bearer, as indicated in the configuration), network resources may be conserved without negatively impacting reception of an Ethernet frame.

As indicated above, FIG. 6 is provided as an example. Other examples may differ from what is described with regard to FIG. 6.

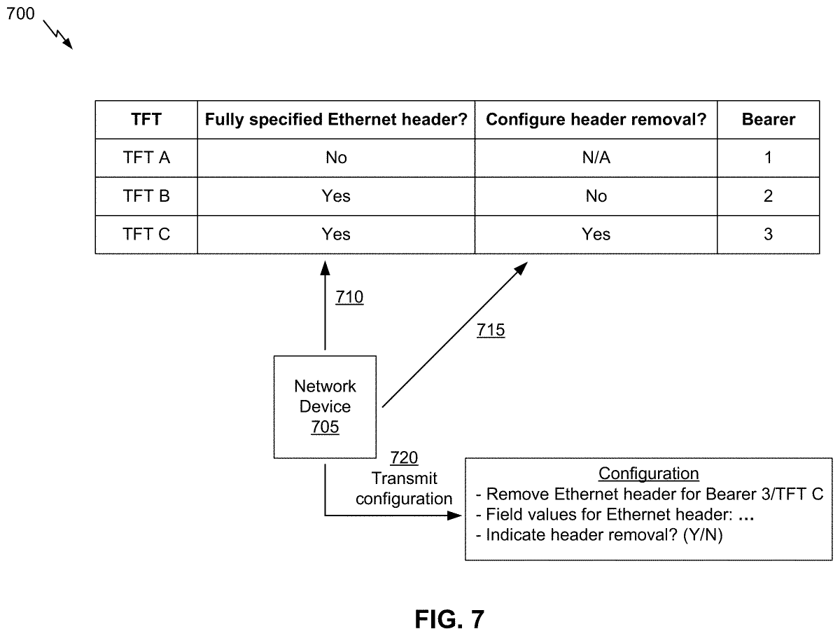

FIG. 7 is a diagram illustrating another example 700 of Ethernet header removal for Ethernet frame delivery over New Radio, in accordance with various aspects of the present disclosure.

FIG. 7 shows example operations performed by a network device 705 in connection with Ethernet header removal for Ethernet frame delivery over New Radio (e.g., over PDCP). In some aspects, the network device 705 may be a base station 110, a network controller 130 (e.g., a UPF device, an AMF device, an SMF device, and/or the like), and/or the like. In some aspects, the network device 705 may be the same device as the transmitter 505. In some aspects, the network device 705 may be the same device as the receiver 605.

As shown by reference number 710, the network device 705 may determine that an Ethernet header is fully specified by a traffic flow template that maps traffic to a bearer. In some aspects, the network device 705 may make this determination when a bearer is being established. The network device 705 may identify the bearer to be established, may identify a traffic flow template that maps traffic to the bearer, and may determine whether the traffic flow template fully specifies an Ethernet header. As shown, a first traffic flow template (e.g., shown as TFT A) does not fully specify an Ethernet header, so Ethernet header removal may not be permitted for traffic transmitted by a bearer to which the first traffic flow template maps the traffic.

As shown by reference number 715, the network device 705 may determine whether to configure Ethernet header removal for the traffic flow template and/or the bearer. In some aspects, the network device 705 may determine whether to configure Ethernet header removal based at least in part on a capability, of a transmitter and/or a receiver associated with the bearer, to support Ethernet header removal. In some aspects, such capability may be indicated to the network device 705 (e.g., in a UE capability report, a base station capability report, and/or the like). In some aspects, if the transmitter and the receiver do not both support Ethernet header removal, then the network device 705 may determine not to configure Ethernet header removal, regardless of whether the Ethernet header is fully specified by the traffic flow template (e.g., as shown in the case of TFT B). In some aspects, if both the transmitter and the receiver support Ethernet header removal and the Ethernet header is fully specified, then the network device 705 may configure Ethernet header removal for the bearer and/or traffic flow templates (e.g., as shown in the case of TFT C).

As shown by reference number 720, the network device 705 may transmit a configuration that indicates whether the Ethernet header is to be removed from traffic that maps to the bearer. As indicated elsewhere herein, the configuration may be generated and/or transmitted in association with establishing the bearer. Additionally, or alternatively, the configuration may be indicated in an RRC message, a NAS message, and/or the like. Additionally, or alternatively, the configuration may be signaled using a traffic flow template format.

As shown, if the network device 705 determines that an Ethernet header is to be removed from traffic that maps to a bearer, the configuration may indicate that the Ethernet header is to be removed from such traffic. As further shown, the configuration may indicate field values for the Ethernet header (e.g., for all fields that are removed from the Ethernet header). The network device 705 may determine the field values based at least in part on the traffic flow template, which may indicate the specific values for the field when the Ethernet header is fully specified by the traffic flow template. In this way, a receiver can reconstruct the Ethernet header when the Ethernet header has been removed.

As further shown, in some aspects, the configuration may indicate whether traffic that maps to the bearer is to include an indication of whether the Ethernet header has been removed from the traffic. In this way, a transmitter can include such indication when necessary, and a receiver can use such indication to determine whether to reconstruct the Ethernet header, as described elsewhere herein.

As indicated above, FIG. 7 is provided as an example. Other examples may differ from what is described with regard to FIG. 7.

FIGS. 8A and 8B are diagrams illustrating examples of fully specified and non-fully specified Ethernet headers, in accordance with various aspects of the present disclosure. The details of the example Ethernet headers shown in FIGS. 8A and 8B are described above in connection with FIG. 3 and FIG. 5. Other examples of fully specified and non-fully specified Ethernet headers may differ from what is described with regard to FIGS. 8A and 8B.

FIG. 9 is a diagram illustrating an example process 900 performed, for example, by a transmitter, in accordance with various aspects of the present disclosure. Example process 900 is an example where a transmitter (e.g., transmitter 405, transmitter 505, base station 110, UE 120, network controller 130, and/or the like) performs operations associated with Ethernet header removal for Ethernet frame delivery over New Radio.

As shown in FIG. 9, in some aspects, process 900 may include determining that an Ethernet header is fully specified by a traffic flow template that maps traffic to a bearer (block 910). For example, the transmitter (e.g., using controller/processor 240, controller/processor 280, controller/processor 290, compression component 520, and/or the like) may determine that an Ethernet header is fully specified by a traffic flow template that maps traffic to a bearer, as described above in connection with FIGS. 4-5.

As further shown in FIG. 9, in some aspects, process 900 may include determining, based at least in part on a configuration, that the Ethernet header is to be removed from traffic that maps to the bearer (block 920). For example, the transmitter (e.g., using controller/processor 240, controller/processor 280, controller/processor 290, compression component 520, and/or the like) may determine, based at least in part on a configuration, that the Ethernet header is to be removed from traffic that maps to the bearer, as described above in connection with FIGS. 4-5.

As further shown in FIG. 9, in some aspects, process 900 may include removing the Ethernet header from one or more packets that map to the bearer based at least in part on the configuration and the determination that the Ethernet header is fully specified by the traffic flow template (block 930). For example, the transmitter (e.g., using controller/processor 240, controller/processor 280, controller/processor 290, compression component 520, and/or the like) may remove the Ethernet header from one or more packets that map to the bearer based at least in part on the configuration and the determination that the Ethernet header is fully specified by the traffic flow template, as described above in connection with FIGS. 4-5.

As further shown in FIG. 9, in some aspects, process 900 may include transmitting the one or more packets via the bearer (block 940). For example, the transmitter (e.g., using controller/processor 240, controller/processor 280, controller/processor 290, antenna 234, antenna 252, communication unit 294, and/or the like) may transmit the one or more packets via the bearer, as described above in connection with FIGS. 4-5. In some aspects, the one or more packets may be transmitted without the Ethernet header.

Process 900 may include additional aspects, such as any single aspect or any combination of aspects described below and/or in connection with one or more other processes described elsewhere herein.

In a first aspect, the Ethernet header is fully specified by the traffic flow template when the traffic flow template includes a specific value for all required fields of the Ethernet header.

In a second aspect, alone or in combination with the first aspect, the Ethernet header is fully specified by the traffic flow template when the traffic flow template includes a specific value for a destination address field, a source address field, and an EtherType field of the Ethernet header.

In a third aspect, alone or in combination with one or more of the first and second aspects, the Ethernet header is fully specified by the traffic flow template when the traffic flow template includes a specific value for a destination address field, a source address field, an EtherType field, and a single virtual local area network (VLAN) tag field of the Ethernet header.

In a fourth aspect, alone or in combination with one or more of the first through third aspects, the Ethernet header is fully specified by the traffic flow template when the traffic flow template includes a specific value for a destination address field, a source address field, an EtherType field, a first virtual local area network (VLAN) tag field, and a second VLAN tag field of the Ethernet header.

In a fifth aspect, alone or in combination with one or more of the first through fourth aspects, the Ethernet header is fully specified by the traffic flow template when only packets with the same Ethernet header map to the bearer.

In a sixth aspect, alone or in combination with one or more of the first through fifth aspects, the configuration is indicated in association with establishing the bearer.

In a seventh aspect, alone or in combination with one or more of the first through sixth aspects, the configuration is indicated in a radio resource control (RRC) message, a non-access stratum (NAS) message, or a combination thereof.

In an eighth aspect, alone or in combination with one or more of the first through seventh aspects, the configuration is signaled using a traffic flow template format.

In a ninth aspect, alone or in combination with one or more of the first through eighth aspects, the configuration indicates whether to transmit, in the one or more packets, an indication of whether the Ethernet header has been removed from the one or more packets.

In a tenth aspect, alone or in combination with one or more of the first through ninth aspects, the one or more packets are transmitted with an indication that the Ethernet header has been removed from the one or more packets.

In an eleventh aspect, alone or in combination with one or more of the first through tenth aspects, the indication is included in a field of a service data adaptation protocol (SDAP) header or a field of a packet data convergence protocol (PDCP) header.

In a twelfth aspect, alone or in combination with one or more of the first through eleventh aspects, the indication is set to a first value when the Ethernet header has been removed or is set to a second value when the Ethernet header has not been removed.

In a thirteenth aspect, alone or in combination with one or more of the first through twelfth aspects, the transmitter is a user equipment, a base station, an application function device, or a user plane function (UPF) device of a core network.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a receiver, in accordance with various aspects of the present disclosure. Example process 1000 is an example where a receiver (e.g., receiver 605, base station 110, UE 120, network controller 130, and/or the like) performs operations associated with Ethernet header removal for Ethernet frame delivery over New Radio.

As shown in FIG. 10, in some aspects, process 1000 may include identifying a bearer associated with a received packet (block 1010). For example, the receiver (e.g., using controller/processor 240, controller/processor 280, controller/processor 290, bearer identification component 610, and/or the like) may identify a bearer associated with a received packet, as described above in connection with FIG. 6.

As further shown in FIG. 10, in some aspects, process 1000 may include determining that the bearer is associated with a configuration indicating that an Ethernet header is to be removed from traffic associated with the bearer (block 1020). For example, the receiver (e.g., using controller/processor 240, controller/processor 280, controller/processor 290, header reconstruction component 615, and/or the like) may determine that the bearer is associated with a configuration indicating that an Ethernet header is to be removed from traffic associated with the bearer, as described above in connection with FIG. 6.

As further shown in FIG. 10, in some aspects, process 1000 may include determining values for fields of the Ethernet header based at least in part on the configuration (block 1030). For example, the receiver (e.g., using controller/processor 240, controller/processor 280, controller/processor 290, header reconstruction component 615, and/or the like) may determine values for fields of the Ethernet header based at least in part on the configuration, as described above in connection with FIG. 6.

As further shown in FIG. 10, in some aspects, process 1000 may include reconstructing the Ethernet header for the received packet using the determined values for the fields based at least in part on the determination that the bearer is associated with the configuration indicating that the Ethernet header is to be removed (block 1040). For example, the receiver (e.g., using controller/processor 240, controller/processor 280, controller/processor 290, header reconstruction component 615, and/or the like) may reconstruct the Ethernet header for the received packet using the determined values for the fields based at least in part on the determination that the bearer is associated with the configuration indicating that the Ethernet header is to be removed, as described above in connection with FIG. 6.

Process 1000 may include additional aspects, such as any single aspect or any combination of aspects described below and/or in connection with one or more other processes described elsewhere herein.

In a first aspect, the configuration is indicated in association with establishing the bearer.

In a second aspect, alone or in combination with the first aspect, the configuration is indicated in a radio resource control (RRC) message, a non-access stratum (NAS) message, or a combination thereof.

In a third aspect, alone or in combination with one or more of the first and second aspects, the configuration is signaled using a traffic flow template format.

In a fourth aspect, alone or in combination with one or more of the first through third aspects, the configuration indicates whether the received packet is to include an indication of whether the Ethernet header has been removed from the received packet.

In a fifth aspect, alone or in combination with one or more of the first through fourth aspects, the Ethernet header is reconstructed based at least in part on an indication, included in the received packet, that the Ethernet header has been removed from the received packet.

In a sixth aspect, alone or in combination with one or more of the first through fifth aspects, the indication is included in a field of a service data adaptation protocol (SDAP) header of the received packet or a field of a packet data convergence protocol (PDCP) header of the received packet.

In a seventh aspect, alone or in combination with one or more of the first through sixth aspects, the indication is set to a first value when the Ethernet header has been removed from the received packet or is set to a second value when the Ethernet header has not been removed from the received packet.

In an eight aspect, alone or in combination with one or more of the first through seventh aspects, the receiver is a user equipment, a base station, or a user plane function (UPF) device of a core network.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network device, in accordance with various aspects of the present disclosure. Example process 1100 is an example where a network device (e.g., network device 705, base station 110, network controller 130, and/or the like) performs operations associated with Ethernet header removal for Ethernet frame delivery over New Radio.

As shown in FIG. 11, in some aspects, process 1100 may include determining that an Ethernet header is fully specified by a traffic flow template that maps traffic to a bearer (block 1110). For example, the network device (e.g., using controller/processor 240, controller/processor 290, and/or the like) may determine that an Ethernet header is fully specified by a traffic flow template that maps traffic to a bearer, as described above in connection with FIG. 7.

As further shown in FIG. 11, in some aspects, process 1100 may include determining that the Ethernet header is to be removed from traffic that maps to the bearer based at least in part on determining that the Ethernet header is fully specified by the traffic flow template (block 1120). For example, the network device (e.g., using controller/processor 240, controller/processor 290, and/or the like) may determine that the Ethernet header is to be removed from traffic that maps to the bearer based at least in part on determining that the Ethernet header is fully specified by the traffic flow template, as described above in connection with FIG. 7.

As further shown in FIG. 11, in some aspects, process 1100 may include transmitting a configuration that indicates that the Ethernet header is to be removed from traffic that maps to the bearer (block 1130). For example, the network device (e.g., using controller/processor 240, controller/processor 290, antenna 234, communication unit 294, and/or the like) may transmit a configuration that indicates that the Ethernet header is to be removed from traffic that maps to the bearer, as described above in connection with FIG. 7.

Process 1100 may include additional aspects, such as any single aspect or any combination of aspects described below and/or in connection with one or more other processes described elsewhere herein.

In a first aspect, the Ethernet header is fully specified by the traffic flow template when the traffic flow template includes a specific value for all required fields of the Ethernet header.

In a second aspect, alone or in combination with the first aspect, the Ethernet header is fully specified by the traffic flow template when the traffic flow template includes a specific value for a destination address field, a source address field, and an EtherType field of the Ethernet header.

In a third aspect, alone or in combination with one or more of the first and second aspects, the Ethernet header is fully specified by the traffic flow template when the traffic flow template includes a specific value for a destination address field, a source address field, an EtherType field, and a single virtual local area network (VLAN) tag field of the Ethernet header.

In a fourth aspect, alone or in combination with one or more of the first through third aspects, the Ethernet header is fully specified by the traffic flow template when the traffic flow template includes a specific value for a destination address field, a source address field, an EtherType field, a first virtual local area network (VLAN) tag field, and a second VLAN tag field of the Ethernet header.

In a fifth aspect, alone or in combination with one or more of the first through fourth aspects, the Ethernet header is fully specified by the traffic flow template when only packets with the same Ethernet header map to the bearer.

In a sixth aspect, alone or in combination with one or more of the first through fifth aspects, the configuration is transmitted in association with establishing the bearer.

In a seventh aspect, alone or in combination with one or more of the first through sixth aspects, the configuration is transmitted in a radio resource control (RRC) message, a non-access stratum (NAS) message, or a combination thereof.

In an eighth aspect, alone or in combination with one or more of the first through seventh aspects, the configuration is transmitted using a traffic flow template format.

In a ninth aspect, alone or in combination with one or more of the first through eighth aspects, the configuration indicates whether traffic that maps to the bearer is to include an indication of whether the Ethernet header has been removed from the traffic.

In a tenth aspect, alone or in combination with one or more of the first through ninth aspects, the configuration indicates values for all fields of the Ethernet header.

In an eleventh aspect, alone or in combination with one or more of the first through tenth aspects, the network device is a base station, a user plane function (UPF) device of a core network, an access management function (AMF) device of the core network, an application function device, or a session management function (SMF) device of the core network.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of communication performed by a transmitter, comprising:
determining that an Ethernet header is fully specified by a traffic flow template that maps traffic to a flow;
determining, based at least in part on a configuration, that the Ethernet header is to be removed from traffic that maps to the flow;
removing the Ethernet header from one or more packets that map to the flow based at least in part on the configuration and the determination that the Ethernet header is fully specified by the traffic flow template; and
transmitting the one or more packets, without the Ethernet header, via the flow.

2. The method of claim 1, wherein the Ethernet header is fully specified by the traffic flow template when the traffic flow template includes a specific value for all required fields of the Ethernet header.

3. The method of claim 1, wherein the Ethernet header is fully specified by the traffic flow template when the traffic flow template includes a specific value for a destination address field, a source address field, and an EtherType field of the Ethernet header.

4. The method of claim 1, wherein the Ethernet header is fully specified by the traffic flow template when the traffic flow template includes a specific value for a destination address field, a source address field, an EtherType field, and a single virtual local area network (VLAN) tag field of the Ethernet header.

5. The method of claim 1, wherein the Ethernet header is fully specified by the traffic flow template when the traffic flow template includes a specific value for a destination address field, a source address field, an EtherType field, a first virtual local area network (VLAN) tag field, and a second VLAN tag field of the Ethernet header.

6. The method of claim 1, wherein the Ethernet header is fully specified by the traffic flow template when only packets with the same Ethernet header map to the flow.

7. The method of claim 1, wherein the configuration is indicated in association with establishing the flow, indicated in a radio resource control (RRC) message, indicated in a non-access stratum (NAS) message, signaled using a traffic flow template format, or a combination thereof.

8. The method of claim 1, wherein the configuration indicates whether to transmit, in the one or more packets, an indication of whether the Ethernet header has been removed from the one or more packets.

9. The method of claim 1, wherein the one or more packets are transmitted with an indication that the Ethernet header has been removed from the one or more packets.

10. The method of claim 9, wherein the indication is included in a field of a service data adaptation protocol (SDAP) header or a field of a packet data convergence protocol (PDCP) header.

11. The method of claim 9, wherein the indication is set to a first value when the Ethernet header has been removed or is set to a second value when the Ethernet header has not been removed.

12. The method of claim 1, wherein the transmitter is a user equipment, a base station, an application function device, or a user plane function (UPF) device of a core network.

13. A method of communication performed by a receiver, comprising:
identifying a flow associated with a received packet;
determining that the flow is associated with a configuration indicating that an Ethernet header is to be removed from traffic associated with the flow;
determining values for fields of the Ethernet header based at least in part on the configuration; and
reconstructing the Ethernet header for the received packet using the determined values for the fields based at least in part on the determination that the flow is associated with the configuration indicating that the Ethernet header is to be removed.

14. The method of claim 13, wherein the configuration is indicated in association with establishing the flow, indicated in a radio resource control (RRC) message, indicated in a non-access stratum (NAS) message, signaled using a traffic flow template format, or a combination thereof.

15. The method of claim 13, wherein the configuration indicates whether the received packet is to include an indication of whether the Ethernet header has been removed from the received packet.

16. The method of claim 13, wherein the Ethernet header is reconstructed based at least in part on an indication, included in the received packet, that the Ethernet header has been removed from the received packet.

17. The method of claim 16, wherein the indication is included in a field of a service data adaptation protocol (SDAP) header of the received packet or a field of a packet data convergence protocol (PDCP) header of the received packet.

18. The method of claim 16, wherein the indication is set to a first value when the Ethernet header has been removed from the received packet or is set to a second value when the Ethernet header has not been removed from the received packet.

19. The method of claim 13, wherein the receiver is a user equipment, a base station, or a user plane function (UPF) device of a core network.

20. A method of communication performed by a network device, comprising:
determining that an Ethernet header is fully specified by a traffic flow template that maps traffic to a flow;
determining that the Ethernet header is to be removed from traffic that maps to the flow based at least in part on determining that the Ethernet header is fully specified by the traffic flow template; and
transmitting a configuration that indicates that the Ethernet header is to be removed from traffic that maps to the flow.

21. The method of claim 20, wherein the Ethernet header is fully specified by the traffic flow template when the traffic flow template includes a specific value for all required fields of the Ethernet header.

22. The method of claim 20, wherein the Ethernet header is fully specified by the traffic flow template when the traffic flow template includes a specific value for a destination address field, a source address field, and an EtherType field of the Ethernet header.

23. The method of claim 20, wherein the Ethernet header is fully specified by the traffic flow template when the traffic flow template includes a specific value for a destination address field, a source address field, an EtherType field, and a single virtual local area network (VLAN) tag field of the Ethernet header.

24. The method of claim 20, wherein the Ethernet header is fully specified by the traffic flow template when the traffic flow template includes a specific value for a destination address field, a source address field, an EtherType field, a first virtual local area network (VLAN) tag field, and a second VLAN tag field of the Ethernet header.

25. The method of claim 20, wherein the Ethernet header is fully specified by the traffic flow template when only packets with the same Ethernet header map to the flow.

26. The method of claim 20, wherein the configuration is transmitted in association with establishing the flow, is transmitted in a radio resource control (RRC) message, is transmitted in a non-access stratum (NAS) message, is transmitted using a traffic flow template format, or a combination thereof.

27. The method of claim 20, wherein the configuration indicates whether traffic that maps to the flow is to include an indication of whether the Ethernet header has been removed from the traffic.

28. The method of claim 20, wherein the configuration indicates values for all fields of the Ethernet header.

29. The method of claim 20, wherein the network device is a base station, a user plane function (UPF) device of a core network, an access management function (AMF) device of the core network, an application function device, or a session management function (SMF) device of the core network.

30. A transmitter for communication, comprising:
a memory; and
one or more processors coupled to the memory, the memory and the one or more processors configured to:
determine that an Ethernet header is fully specified by a traffic flow template that maps traffic to a flow;
determine, based at least in part on a configuration, that the Ethernet header is to be removed from traffic that maps to the flow;
remove the Ethernet header from one or more packets that map to the flow based at least in part on the configuration and the determination that the Ethernet header is fully specified by the traffic flow template; and
transmit the one or more packets, without the Ethernet header, via the flow.
